(19) United States
(12) Patent Application Publication
(10) Pub. No.: US 2015/0370911 A1
(43) Pub. Date: Dec. 24, 2015

(54) INFORMATION PROVIDING METHOD, APPARATUS AND PROGRAM

(71) Applicant: HITACHI, LTD., Chiyoda-ku, Tokyo (JP)

(72) Inventors: Hajime HANAWA, Tokyo (JP); Takahiro INOUE, Tokyo (JP); Yuji MIZOTE, Tokyo (JP)

(73) Assignee: Hitachi, Ltd., Chiyoda-ku, Tokyo (JP)

(21) Appl. No.: 14/766,241

(22) PCT Filed: Nov. 8, 2013
(86) PCT No.: PCT/JP2013/080236

§ 371 Date: Aug. 6, 2015

(51) Int. Cl. G06F 17/30; G06F 17/24

(52) U.S. Cl. CPC G06F 17/30893; G06F 17/24

(57) ABSTRACT

An information providing method is used to modify a display of a Web page provided to a terminal appropriately to a user. The action log includes identification information of the Web page and an operation content on the Web page by the user. The computer saves information related to a transition of the Web page as transition information based on the acquired action log, saves an operation content included in the acquired action log as operation information, extracts a user having a transition history same as a transition history of a user currently viewing a Web page, acquires an operation content of the extracted user on a Web page the user currently viewing a Web page views next, and modifies, based on the acquired operation content, a display of the Web page the user currently viewing a Web page views next.

### BACKGROUND

The present invention is related to an information providing technique to acquire an action log of a terminal of a user and to provide a Web page for display on the terminal in a modified manner.

There are many Web applications for business and commercial purposes. However, when the Web applications offer low usability such as low operability of the applications, business efficiency may be reduced while conversion rate, or the like, is also reduced. Accordingly, usability of Web applications are expected to be improved. One of the methods for improving usability of Web applications which includes a technique to analyze users' actions by the Web applications understanding what the users actually do has been known. The following process will be executed according to this user action analysis technique.

1. User's operation on the Web is accumulated.

2. Information matching the user's preference based on the acquired information is provided to the user.

3. Analysis results are presented to the administrator of the Web application based on the acquired information so as to promote improvement on the Web application.

International Publication No. 2011/161735 (Patent Document 1) and Japanese Unexamined Patent Application Publication No. 2011-128968 (Patent Document 2) disclose such technique.

Patent Document 1 discloses “When transmitting a webpage to a web browser, a web server detects an operation log acquisition function which is operating in the client's browser, detects web page text layout changes, and inserts and transmits a saved difference detection function. The web browser executes the difference detection function that was inserted in the web page that was received and saves the text layout of the webpage as a first text layout. Further, the web browser executes the operation log acquisition function and generates and saves the operation log for the web page, executes the difference detection function, compares the text layout of the webpage and the first text layout, and if there is a disparity, makes a link between the disparity and the operation log and saves them. The log coordination server retrieves the operation of the web application, using the disparity that was linked to the operation log and saved.”.

Patent Document 2 discloses“A user terminal 12 sequentially transmits operation log data showing an operation performed by a user to a change instruction server 13 in accordance with web page browsing. The change instruction server 13 stores operation log data received from any user terminal 12 in the past in an operation log DB. The change instruction server 13 extracts operation log data having predetermined similarity to operation log data newly received from the user terminal 12 from an operation log DB, and generates instruction data for instructing the user to highlight content in a web page recommended to the user on the basis of the extracted operation log data. The user terminal 12 changes display to the web page according to instruction data transmitted to the user terminal 12 from the change instruction server 13.”.

[Patent Document 1] International Publication No. 2011/161735

[Patent Document 2] Japanese Unexamined Patent Application Publication No. 2011-128968

### SUMMARY

Patent Document 1 includes disclosure regarding the acquisition of operation information (operation time, session ID, and operation (copy or click)) of a user, but does not include indication regarding automatic improvement of Web pages based on the operation information.

Further, Patent Document 2 includes disclosure regarding improvement of the Web pages viewed by a user in an automatic manner by extracting and classifying the user's preferences from the user's activities, and based on the operations by other users having similar preferences.

According to Patent Document 2, in order to specify user's preferences, a keyword is extracted from the operation by the user, specific contents, or the like, that correspond to the extracted keyword based on a preference determination directory are specified, and the specific contents, or the like, are extracted as the preference data of the user.

Since the Web page is improved according to Patent Document 2 by using the preference determination directory, 3 following issues arise. The first issue is that the preference determination directory needs to be constructed, which takes personnel expenses. The second issue is that since the contents, or the like, to which the preference data belongs, rely on the preference determination directory, depending on the classification of the types of contents, accuracy of the contents matching the preference of the user varies. The third issue is that new words, coined words, and industry-specific words need to be reflected in the preference determination directory each time such word arises, which takes personnel expenses.

Accordingly, the objective of the present invention is to provide an information providing method, which reduces the personnel expenses, and provides the information demanded by a user in an accurate manner.

According to the present invention to resolve the described above object, there is provided an information providing method to modify a display of a Web page provided to a terminal appropriately to a user of a computer configured to acquire an action log of the user of the terminal, wherein the action log includes identification information of the Web page and an operation content on the Web page by the user, wherein the method includes: a step of acquiring, by the computer, the action log; a step of saving, by the computer, information related to a transition of the Web page as transition information based on the acquired action log; a step of saving, by the computer, an operation content included in the acquired action log as operation information; a step of extracting, by the computer, a user having a transition history same as a transition history of a user currently viewing a Web page by referencing the transition information; a step of acquiring, by the computer, an operation content of the extracted user on a Web page the user currently viewing a Web page views next by referencing the operation information; and a step of modifying, by the computer, based on the acquired operation content, a display of the Web page the user currently viewing a Web page views next.

This invention enables to provide an information providing method, which reduces the personnel expenses, and provides the information demanded by a user in an accurate manner.

Other objects, configurations, and effects than those described above are revealed in the following description of an embodiment.

### BRIEF DESCRIPTION OF THE DRAWINGS

FIG. 1 is an explanatory diagram of an outline of embodiment 1 according to the present invention.

FIG. 2 is an explanatory diagram of an example of how a Web page is displayed according to embodiment 1.

FIG. 3 is system configuration diagram according to embodiment 1.

FIG. 4 is a flowchart of action log information acquisition process according to embodiment 1.

FIG. 5 is an explanatory diagram of an action log according to embodiment 1.

FIG. 6 is an explanatory diagram of a transition information table according to embodiment 1.

FIG. 7 is an explanatory diagram of an operation information table according to embodiment 1.

FIG. 8 is an explanatory diagram of the transition information table in which the dummy value is registered according to embodiment 1.

FIG. 9 is an explanatory diagram of a related ID generation process according to embodiment 1.

FIG. 10 is a flowchart of an identical transition user operation extraction process according to embodiment 1.

FIG. 11A is an explanatory diagram of viewing user immediate transition information according to embodiment 1.

FIG. 11B is an explanatory diagram of another user immediate transition information according to embodiment 1.

FIG. 11C is an explanatory diagram of transition information of a viewing user according to embodiment 1.

FIG. 11D is an explanatory diagram of the transition information of another user according to embodiment 1.

FIG. 11E is an explanatory diagram of operation contents of the another user on the Web page which will be displayed next for the viewing user according to embodiment 1.

FIG. 12 is an explanatory diagram of a display modification script according to embodiment 1.

FIG. 13 is an explanatory diagram of an exemplary display of a Web page according to embodiment 1.

FIG. 14 is an explanatory diagram of an exemplary display of the Web page according to embodiment 1.

FIG. 15 is a configuration diagram of an information providing apparatus according to embodiment 2.

FIG. 16 is a flowchart of an operation information linking process according to embodiment 2.

FIG. 17 is an explanatory diagram of the operation contents of plurality of other users acquired by an operation information linking unit according to embodiment 2.

FIG. 18 is an explanatory diagram of a weight table according to embodiment 2.

FIG. 19 is a flowchart of the identical transition user operation extraction process according to embodiment 3.

FIG. 20 is a flowchart of a page circulation exclusion process according to embodiment 3.

FIG. 21 is an explanatory diagram of the page circulation exclusion process according to embodiment 3.

### DETAILED DESCRIPTION OF THE EMBODIMENTS

Hereinafter, embodiments for implementing the present invention will be described with reference to drawings. For clarity purposes, the descriptions and the drawings below are omitted or simplified whenever appropriate. Further, identical elements depicted in multiple drawings are assigned with the same reference numerals, and repetitive descriptions thereof shall be, for clarity of description, avoided when necessary.

### Embodiment 1

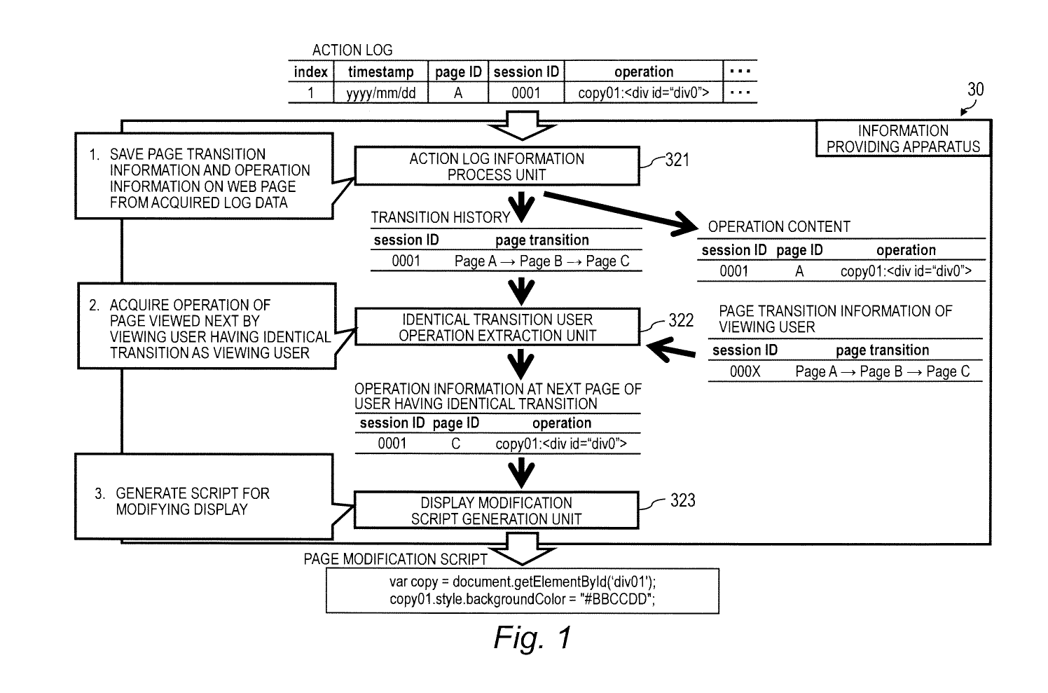

Hereinafter, embodiment 1 will be described with reference to FIG. 1 to FIG. 14.

FIG. 1 is an explanatory diagram of an outline of embodiment 1 according to the present invention.

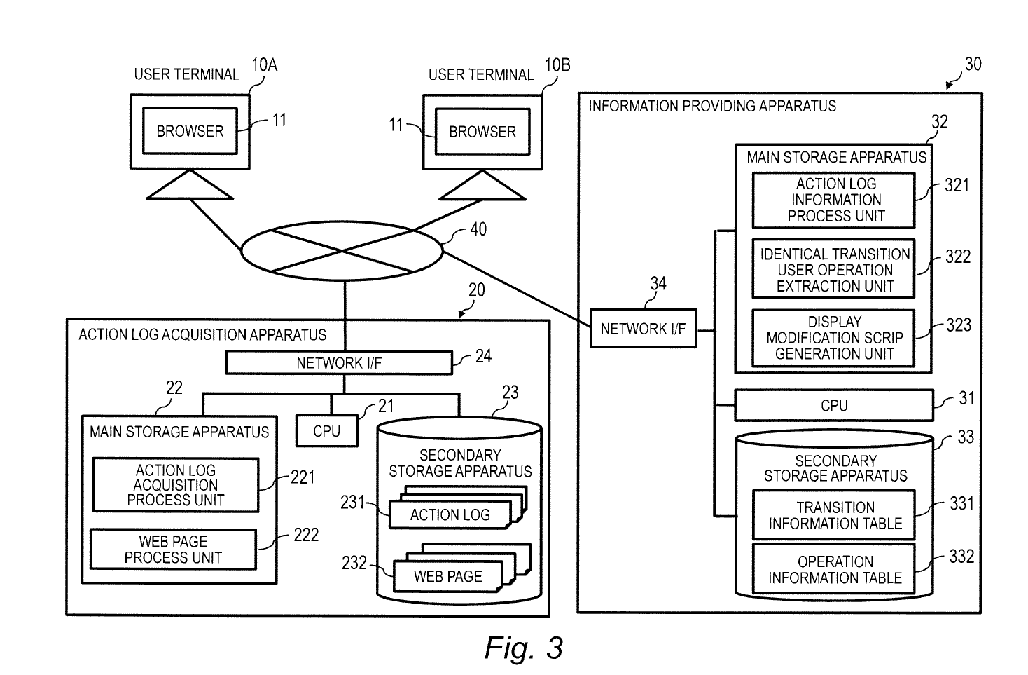

According to the present invention, an information providing apparatus 30 saves the information related to transition of Web pages by a user based on an obtained action log of the user as a transition information table 331 (see FIG. 3), saves the history of the operation content on the Web pages by the user at an operation information table 332 (see FIG. 3), and, based on the transition information table 331, extracts a user having the same transition history as the transition history of the user currently viewing the Web page. Then, the information providing apparatus 30 automatically improves the Web page viewed by the user by modifying the Web page the user, who is currently viewing the Web page, is viewing next based on the operation content of the extracted user, whereby it becomes possible to reduce personnel expenses while providing the information the user demands with better accuracy.

The information providing apparatus 30 includes an action log information process unit 321, an identical transition user operation extraction unit 322, and a display modification script generation unit 323.

The action log information process unit 321 extracts the transition history of Web pages and the history of operation contents from the obtained action log.

Next, when the user who is currently viewing a Web page is transitioning to a next Web page, the identical transition user operation extraction unit 322 refers to the transition information table 331 to extract a user whose transition history is identical with the transition history of the user. Then, the identical transition user operation extraction unit 322 refers to the operation information table 332 and extracts the operation content at the next Web page of the extracted user.

Finally, based on the operation content extracted by the identical transition user operation extraction unit 322, the display modification script generation unit 323 generates a Web page modification script which is a script configured to modify the display content of the Web page to which the user who is currently viewing a Web page will transition, has the generated Web page modification script embedded in the next Web page to which the user will transition, and sends the same to a user terminal 10 (see FIG. 3).

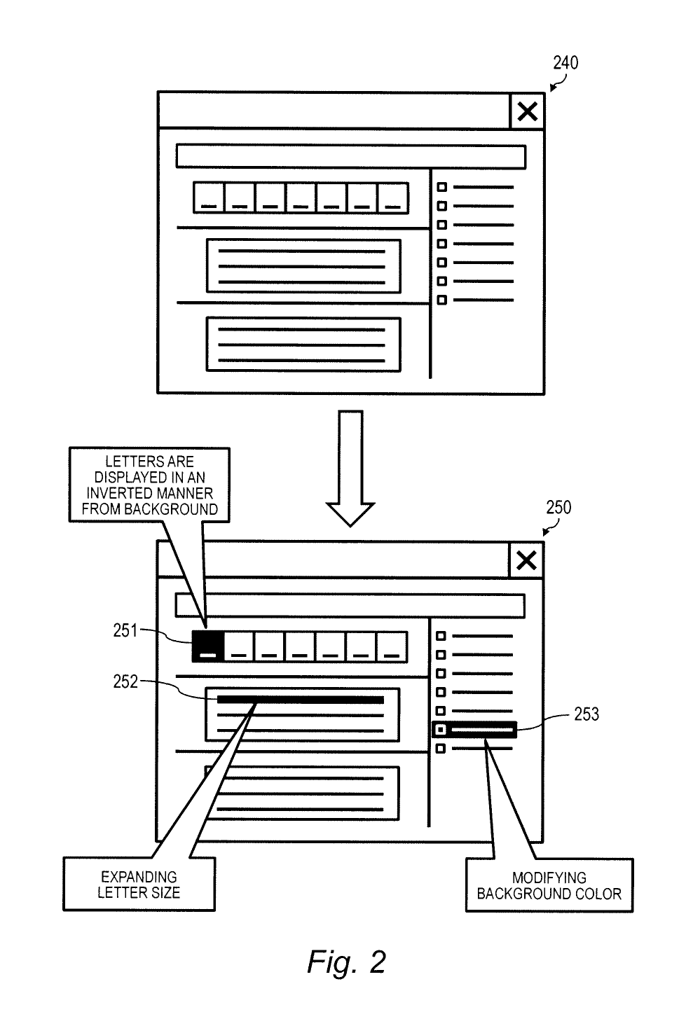

FIG. 2 is an explanatory diagram of an example of how a Web page is displayed according to embodiment 1.

A display screen 240 includes a display screen prior to the Web page being modified, whereas a display screen 250 includes a display screen after the Web page has been modified by the Web page modification script.

The display modification script generation unit 323 generates, based on the operation content extracted by the identical transition user operation extraction unit 322, a script for modifying the Web page such that the portion thereof another user operated will be displayed in an emphasized manner.

For example, a display area 251 of the display screen 250 is displayed in an emphasized manner where letters are displayed in an inverted manner compared to the background, and a display area 252 is displayed in an emphasized manner where the size of the letters in the display area 252 is expanded compared with that in the display screen 240, and a display area 253 is displayed in an emphasized manner by having a background color thereof different from the background color of the corresponding area of the display screen 240.

By this, information that is suited for the user will be displayed in an emphasized manner, and, in addition, it will be possible to improve the conversion rate and efficiency of business.

FIG. 3 is system configuration diagram according to embodiment 1.

The system according to the present embodiment includes user terminals 10A and 10B (hereinafter, collectively referred to as user terminal 10), an action log acquisition apparatus 20, and an information providing apparatus 30. The user terminal 10, the action log acquisition apparatus 20, and the information providing apparatus 30 are connected with one another via a network 40.

The user terminal 10 displays a Web page, via a browser 11, desired by a user. The user terminal 10 may include a regular personal computer, or a smart phone, or a tablet terminal, or the like.

The action log acquisition apparatus 20 distributes the Web page to the user terminal 10, and acquires an action log, which includes a Web page ID that includes identification information of a Web page at which the user conducted an operation and the operation content.

The information providing apparatus 30, based on the action log acquired by the action log acquisition apparatus 20, embeds a display modification script configured to modify the display of the Web page which will be displayed next on the user terminal 10 so that it will be displayed appropriately to the user on the user terminal 10, and sends the Web page to the user terminal 10.

When the user terminal 10 receives an operation of a request for a Web page which will be viewed next, a Web page request which includes the ID of the Web page will be sent to the action log acquisition apparatus 20. When the action log acquisition apparatus 20 receives the Web page request, the action log acquisition apparatus 20 acquires the Web page included in the Web page request, and sends the acquired Web page to the information providing apparatus 30. The information providing apparatus 30 embeds a display modification script when necessary into the received Web page, and sends the Web page to the user terminal 10 which sent the Web page request.

The details of the action log acquisition apparatus 20 will be described. The action log acquisition apparatus 20 includes a CPU 21, a main storage apparatus 22, a secondary storage apparatus 23, and a network interface (network I/F) 24. These elements are connected with one another via a bus.

The CPU 21 executes each program stored at the main storage apparatus 22. The main storage apparatus 22 stores therein a program corresponding to an action log acquisition process unit 221, and a program corresponding to a Web page process unit 222. When the CPU 21 executes these programs, the action log acquisition process unit 221 and the Web page process unit 222 are implemented.

The action log acquisition process unit 221 acquires an action log from the user terminal 10, and stores the acquired action log as an action log 231 at the secondary storage apparatus 23. When the Web page process unit 222 receives the Web page request from the user terminal 10, the Web page process unit 222 acquires the Web page corresponding to the Web page request received from a Web page 232 of the secondary storage apparatus 23, and sends the acquired Web page to the user terminal 10 via the information providing apparatus 30.

The action log 231 and the Web page 232 are stored at the secondary storage apparatus 23. They are loaded to the main storage apparatus 22, and thereby become readable and writable to CPU 21. The action log 231 includes a history of operation contents of each user which the action log acquisition apparatus 20 acquired from the user terminal 10, and details of which will be described with reference to FIG. 5. The Web page 232 includes a Web page that can be provided to the user terminal 10.

A network interface 24 includes an interface configured to connect the action log acquisition apparatus 20 with the network 40.

Next, details of the information providing apparatus 30 will be described. The information providing apparatus 30 includes a CPU 31, a main storage apparatus 32, a secondary storage apparatus 33, and a network interface (network I/F) 34. These elements are connected with one another via a bus.

The CPU 31 executes each program stored at the main storage apparatus 32. The main storage apparatus 32 stores therein a program corresponding to the action log information process unit 321, a program corresponding to the identical transition user operation extraction unit 322, and a program corresponding to the display modification script generation unit 323. When the CPU 31 executes these programs, the action log information process unit 321, the identical transition user operation extraction unit 322, and the display modification script generation unit 323 are implemented.

The action log information process unit 321 acquires an action log from the action log acquisition apparatus 20, extracts information related to transition of Web pages from the acquired action log, and stores the extracted information at the transition information table 331 of the secondary storage apparatus 33. Also, the action log information process unit 321 acquires the operation content of the user from the acquired action log, and stores the operation information table 332 of the secondary storage apparatus 33.

The identical transition user operation extraction unit 322 refers to the transition information table 331 so as to identify a user whose transition history is identical with the transition history of a user currently viewing a Web page. Then, the identical transition user operation extraction unit 322 refers to the operation information table 332 so as to acquire the operation contents of the identified user on the Web page which the user, who is currently viewing a Web page, will view next.

The display modification script generation unit 323 generates a display modification script configured to modify the display of the next Web page based on the operation content extracted by the identical transition user operation extraction unit 322.

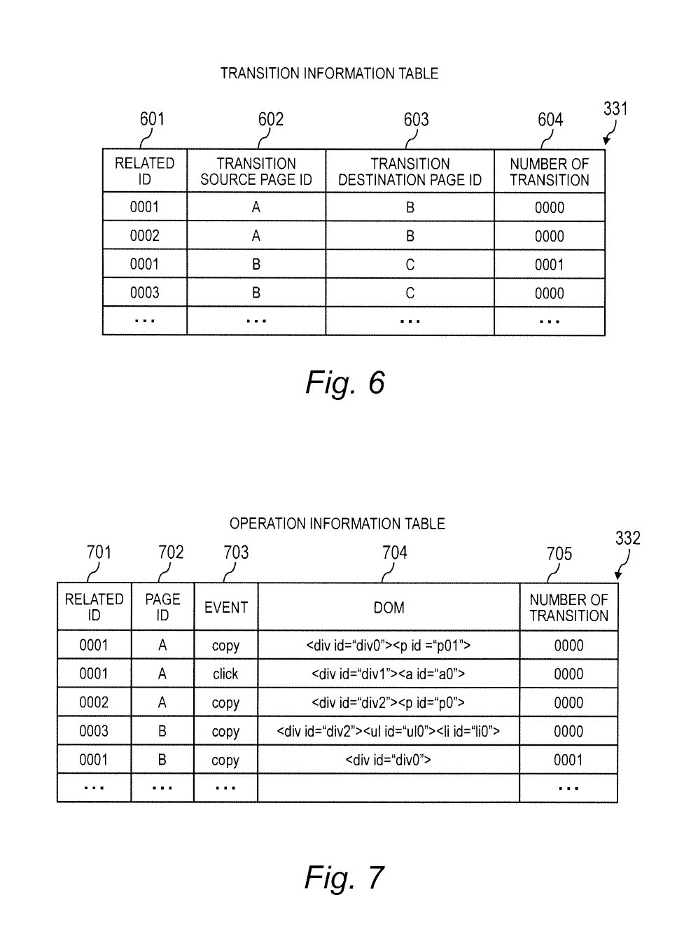

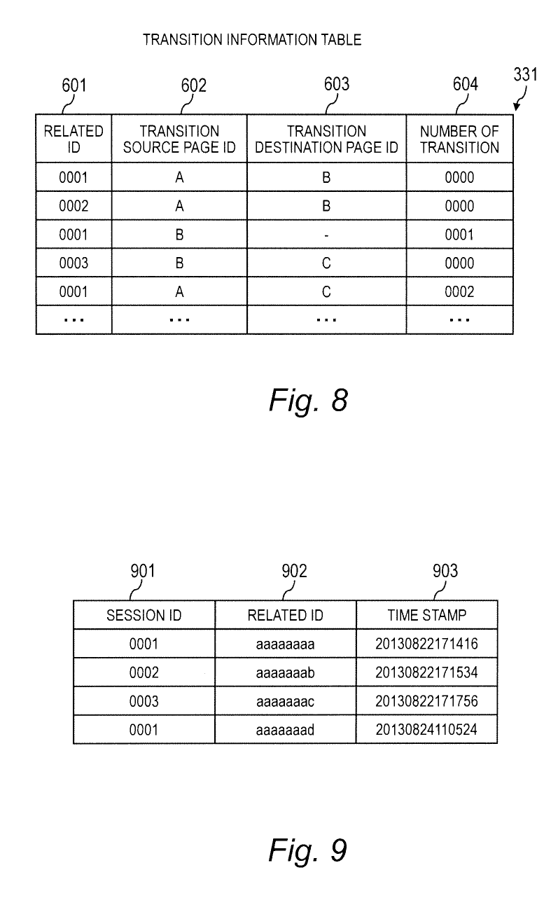

The secondary storage apparatus 33 stores therein the transition information table 331 and the operation information table 332. The transition information table 331 stores therein information related to the transition of Web pages of each user, and the details thereof will be described with reference to FIG. 6 and FIG. 8. The operation information table 332 stores therein the operation contents on Web pages by each user, and the details thereof will be described with reference to FIG. 7.

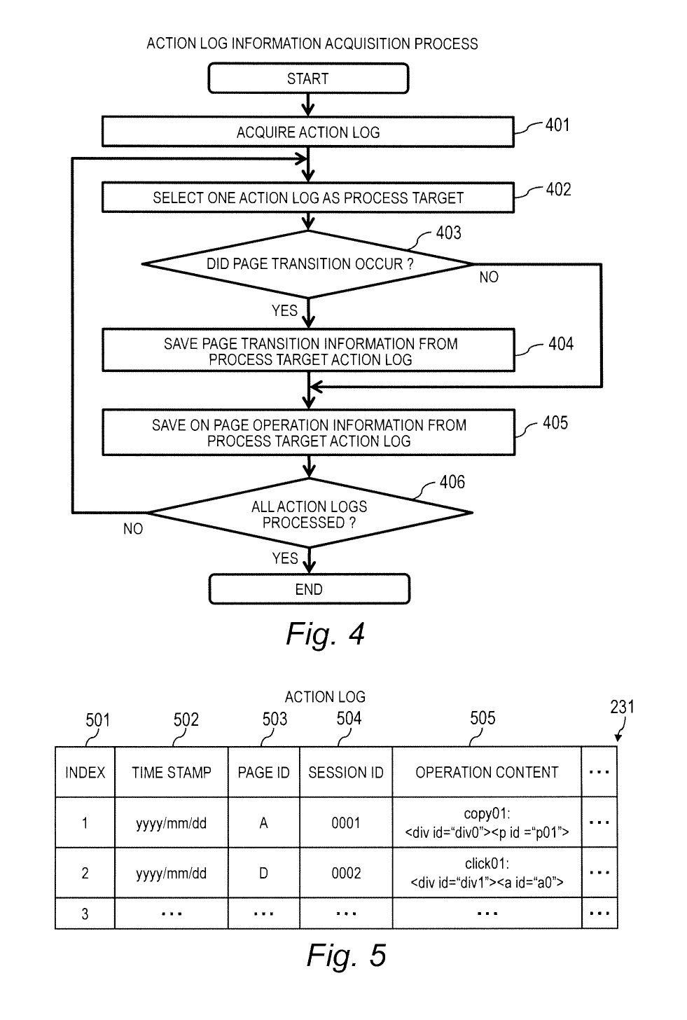

FIG. 4 is a flowchart of the action log information acquisition process according to embodiment 1. The action log information acquisition process is executed by the action log information process unit 321 at a predetermined timing.

Firstly, the action log information process unit 321 acquires the action log 231 from the action log acquisition apparatus 20 (401).

Here, the action log 231 will be described with reference to FIG. 5. FIG. 5 is an explanatory diagram of the action log 231 according to embodiment 1.

The action log 231 includes an index 501, a time stamp 502, a page ID 503, a session ID 504, and an operation content 505.

The index 501 registers therein unique identification information of the action log 231. The time stamp 502 registers therein time information which includes year, month, date, and time, or the like, when a user operation on a Web page takes place. The page ID 503 registers therein an ID of a Web page where the user operation took place. The session ID 504 registers therein a session ID which is allocated when the user terminal 10 receives a Web page provided from the action log acquisition apparatus 20. The operation content 505 registers therein contents of an operation on a Web page.

For example, in FIG. 5, the action log whose index includes “1” indicates a user, whose session ID includes “0001,” had a copy operation on a Web page, whose page ID includes “A.” Also, in the action log whose index includes “2,” a user, whose session ID includes “0002,” had a click operation on a Web page, whose page ID includes “D.”

Returning to FIG. 4, the description of the action log information acquisition process will continue. After executing the process of Step 401, the action log information process unit 321 selects a record (process target action log) which becomes a process target from the records in the action log 231 acquired in the process of Step 401 (402). To be more specific, the action log information process unit 321 sorts the records of the action log 231 in an order of the time stamp per session ID so as to select a process target record in a chronological order of the time stamp per session ID.

Next, the action log information process unit 321 refers to the action log of the process target which was selected in the process of Step 402 so as to determine whether or not a Web page transition took place (403). To be more specific, the action log information process unit 321 determines that a Web page transition took place when the content of the operation content 505 included in the process target action log includes a Web page transition process, and a Web page ID of the transition destination is different from the page ID of the action log of the process target.

When it is determined in the process of Step 403 that a Web page transition took place, the action log information process unit 321 acquires a post-change Web page ID and a immediately before change Web page ID as the transition history, and registers the acquired transition history at the transition information table 331 (401).

Here, the transition information table 331 will be described with reference to FIG. 6. FIG. 6 is an explanatory diagram of the transition information table 331 according to embodiment 1.

The transition information table 331 includes a related ID 601, a transition source page ID 602, a transition destination page ID 603, and a number of transition 604.

The related ID 601 registers therein identification information of a user. Here, the related ID 601 registers therein a session ID of a process target record. The transition source page ID 602 registers therein an immediately before change Web page ID. The transition destination page ID 603 registers therein a post change Web page ID. The number of transition 604 registers therein the number of transitions of Web pages.

In the process of Step 404, the action log information process unit 321 registers at the related ID 601 the session ID registered at the session ID 504 of a process target record, registers at the transition source page ID 602 the Web page ID of the process target record, and registers at the transition destination page ID 603 the transition destination Web page ID of the operation content of the process target record.

Note that when it is determined in the process of Step 403 that a Web page transition took place, the action log information process unit 321 adds 1 to the number of transition which corresponds to the session ID of the process target record, and, in the process of Step 404, and registers the transition number at the number of transition 604. Also, during the adding process concerning the transition number in the process of Step 403, when it is determined for the first time a Web page transition took place for each session ID, the number of transition is set as 0.

Next, the action log information process unit 321 registers the operation content of the process target record at the operation information table 332 (405).

Here, the operation information table 332 will be described with reference to FIG. 7. FIG. 7 is an explanatory diagram of the operation information table 332 according to embodiment 1.

The operation information table 332 includes a related ID 701, a page ID 702, an event 703, a DOM (Document Object Model) 704, and a number of transition 705.

The related ID 701 registers therein identification information of a user. The transition information table 331 and the operation information table 332 are correlated to one another by the identification information registered at the related ID 601 and related ID 701. The page ID 702 registers therein the Web page ID of a Web page where an operation took place. The event 703 registers therein a type of operation. The DOM 704 registers therein an HTML tag (which may include an attribute value of the HTML) of a portion where the operation took place. The number of transition 705 registers therein the number of transition up to the Web page where the operation took place.

In the process of Step 405, the action log information process unit 321 registers at the related ID 701 the session ID registered at the session ID 504 of a process target record, registers at the page ID 702 the page ID of the process target record, registers at the event 703 the type of the operation of the operation content of the process target record, registers at the DOM 704 the operation location of the operation content of the process target record, and registers at the number of transition 705 the number of transition which was calculated by the action log information process unit 321.

When it is determined in the process of Step 403 that no Web page transition took place, the action log information process unit 321 proceeds to the process of Step 405 instead of executing the process of Step 404, and registers the operation content at the operation information table 332.

Next, the action log information process unit 321 makes a determination as to whether the processes of Steps 403 to 405 have been executed with respect to all the records of the action log 231 acquired in the process of Step 401 (406).

When it is determined in the process of Step 406 that the processes of

Steps 403 to 405 have not been executed with respect to all the records of the action log 231 acquired in the process of Step 401, the action log information process unit 321 returns to the process of Step 402, selects the next process target record, and executes the processes of Steps 403 to 405.

On the other hand, when it is determined in the process of Step 406 that the processes of Steps 403 to 405 have been executed with respect to all the records of the action log 231 acquired in the process of Step 401, the action log information process unit 321 ends the process.

Note that the action log information process unit 321 is operable to register at the transition information table 331 that a Web page transition took place when an operation to close the Web page took place. In the process of Step 403, when the operation content 505 of the process target record indicates the operation to close the Web page, the action log information process unit 321 determines that a Web page transition took place, and proceeds to the process of Step 404. In the process of Step 404, the action log information process unit 321 registers the session ID of the process target record at the related ID 601 of the transition information table 331, registers the page ID of the process target record at the transition source page ID 602, registers a dummy value “-” at the transition destination page ID 603, and registers the number of transition corresponding to the session ID of the process target record at the number of transition 604.

The transition information table 331 in which the dummy value is registered will be described with reference to FIG. 8. FIG. 8 is an explanatory diagram of the transition information table 331 in which the dummy value is registered according to embodiment 1. Note that the configuration of the transition information table 331 illustrated in FIG. 8 that is the same as that of the transition information table 331 illustrated in FIG. 6 will be given the same reference numerals as those in FIG. 6 and the description thereof will be omitted.

The transition destination page ID 603 of the record, whose related ID includes “0001,” whose transition source page ID includes “B,” and whose number of transition includes “0001,” registers therein the dummy value “-.”

By registering the dummy value, it becomes possible to manage even the history of a user closing a Web page as the transition history, and therefore, it becomes possible to extract a user whose transition history is identical with that of the user currently viewing the Web page by using the transition history which even includes the operation of the closing of the Web page.

Note that although the session ID is used as the related ID in order to correlate the transition information table 331 and the operation information table 332, a related ID that is generated by executing a predetermined conversion process with respect to the session ID may be used. In this case, after acquiring the action log 231 in the process of Step 401, and before executing Step 402, the action log information process unit 321 refers to the acquired action log 231 so as to generate the related ID by executing a predetermined conversion process with respect to the session ID. This related ID generating process will be described with reference to FIG. 9.

FIG. 9 is an explanatory diagram of the related ID generation process according to embodiment 1.

FIG. 9 illustrates the relationship between the session ID and the time stamp of the action log 231 that are acquired in Step 401 are extracted, and the related ID which is generated by executing a predetermined process with respect to the session ID. The extracted session ID is indicated in a session ID 901, the extracted time stamp is indicated in a time stamp 903, and the related ID is indicated in a related ID 902.

When the session ID, which may be identical with another, is used after a predetermined amount of time has already passed since the last time the session ID was used, the session runs out of time and the session ID will be allocated to another user. Accordingly, it will be necessary for the action log information process unit 321 to generate another related ID when the session ID remains the same but when the time information indicated in the time stamp indicates that a predetermined amount of time has passed for the session ID since the session ID was used last time.

For example, in FIG. 9, the session IDs “0001” include one that was used at “20130822171416” as one time stamp indicates while another one of the same ID that was used at “20130824110524.” The session ID “0001” that was used at “20130824110524” was used after a predetermined amount of time had passed since it was used at “20130822171416,” and therefore has run out of time. Accordingly, the action log information process unit 321 generates separate related IDs (related ID “aaaaaaaa” and “aaaaaaad”) for these. For example, the action log information process unit 321 may generate another related ID by executing a predetermined conversion process where the related ID of a session ID which is used after it has times out is inputted as the session ID and the time stamp.

Note that since no time out of a session ID occurs for a predetermined period of time after a restart of the action log acquisition apparatus 20, the action log information process unit 321 may generate the related ID without considering the above stated time out.

By the above, even when the same session ID is allocated to separate users, the action log information process unit 321 is operable to generate unique related IDs that do not overlap with one another.

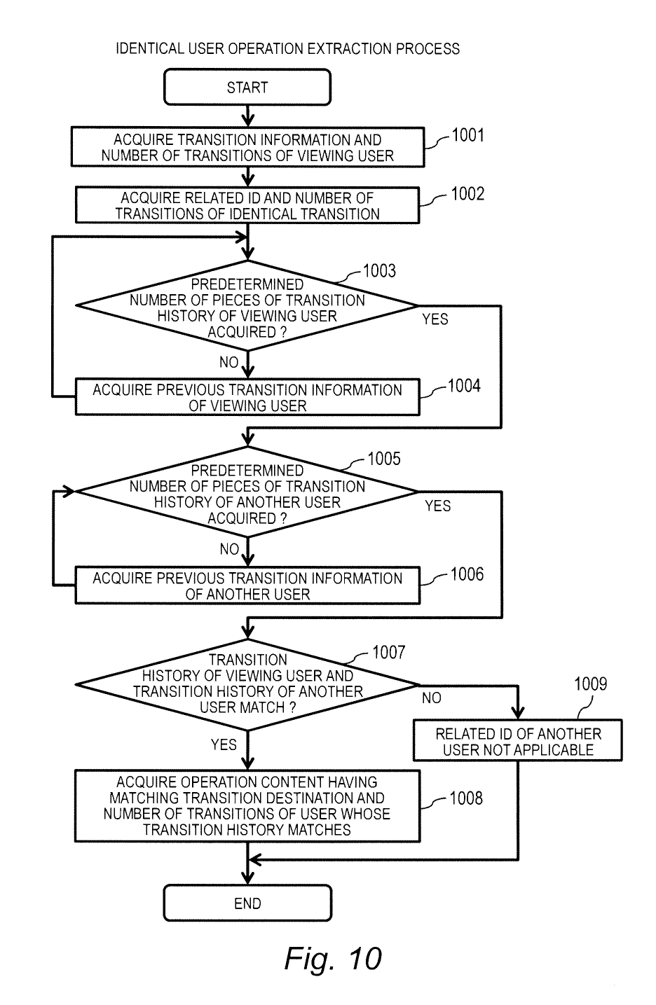

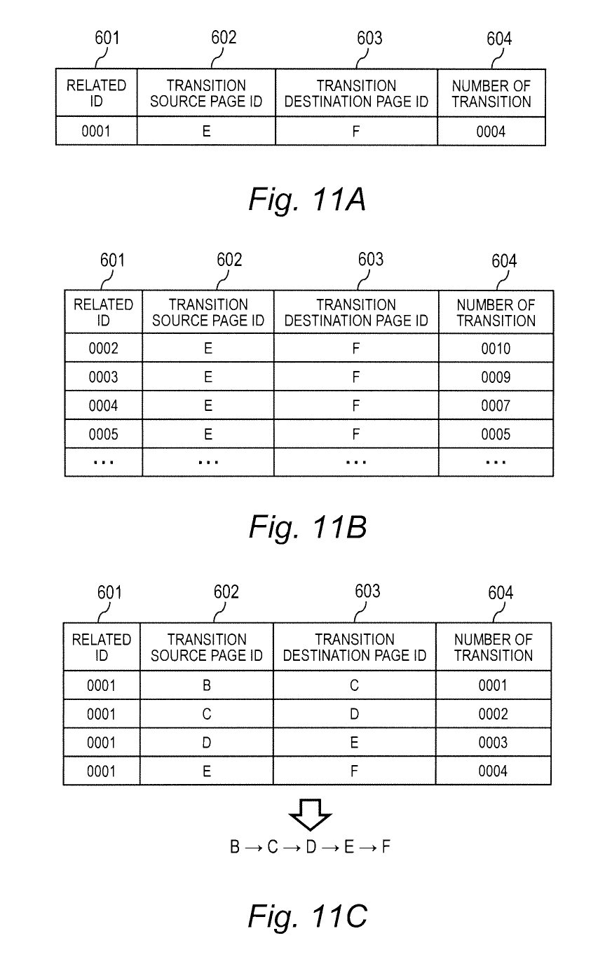

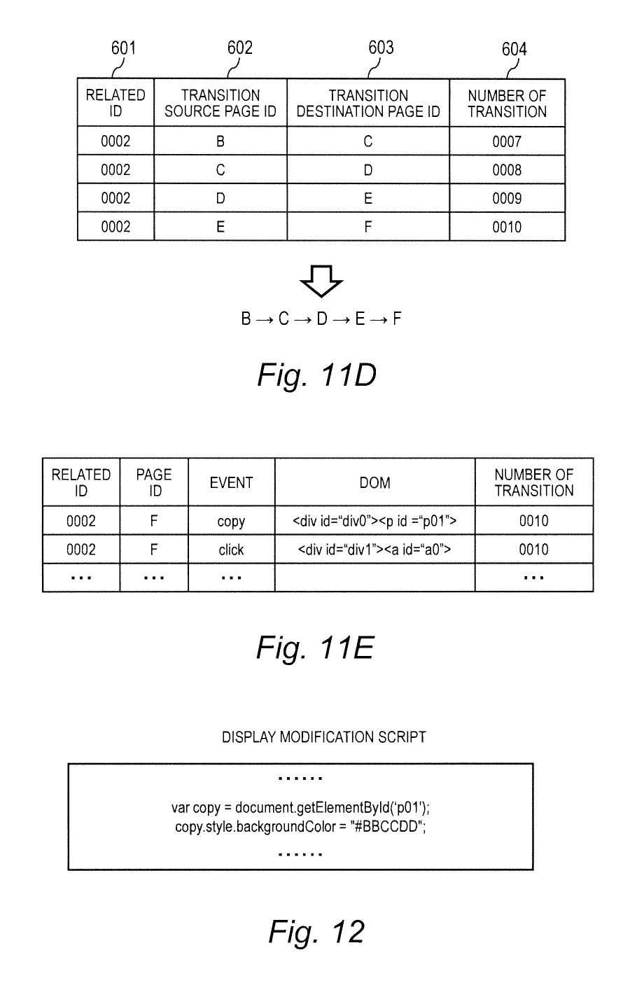

Next, an identical transition user operation extraction process which will be executed by the identical transition user operation extraction unit 322 will be described with reference to FIG. 10, and FIG. 11A through FIG. 11E.

FIG. 10 is a flowchart of the identical transition user operation extraction process according to embodiment 1. The identical transition user operation extraction process is executed by the identical transition user operation extraction unit 322 when a user (viewing user) who is presently viewing a Web page transitions to another Web page. For example, it will be executed when the information providing apparatus 30 receives a Web page which will be provided to a user from the action log acquisition apparatus 20.

Firstly, the identical transition user operation extraction unit 322 refers to the transition information table 331 so as to acquire from the transition information of the viewing user the transition information that has the largest transition number as viewing user immediate transition information (1001). To be more specific, the identical transition user operation extraction unit 322 acquires for the related ID of the transition information table 331 a record in which the related ID corresponding to the session ID included in the Web page received from the action log acquisition apparatus 20, and acquires out of the acquired records a record that has the largest value registered for the number of transition 604 as the viewing user immediate transition information. Here, for example, consider that the transition history illustrated in FIG. 11A is acquired as the viewing user immediate transition information. FIG. 11A is an explanatory diagram of the viewing user immediate transition information according to embodiment 1. According FIG. 11A, in the process of Step 1001 the related ID “0001,” the transition source page ID “E,” the transition destination page ID “F,” and the number of transition “0004” will be acquired. The page ID which indicates the transition history of the user includes “E→F.”

Next, the identical transition user operation extraction unit 322 refers to the transition information table 331 so as to acquire a record of the transition history identical to the viewing user immediate transition information acquired in the process of Step 1001 as another user immediate transition information (1002). To be more specific, the identical transition user operation extraction unit 322 registers at the related ID 601 a related ID different from the related ID acquired in the process of Step 1001, registers at the transition source page ID 602 a transition source page ID acquired in the process of Step 1001, and registers at the transition destination page ID 603 a transition destination page ID acquired in the process of Step 1001. Then, the identical transition user operation extraction unit 322 acquires out of the acquired records a record that has the largest value registered for the number of transition 604 as the another viewer immediate transition information.

In the process of Step 1002, consider FIG. 11B was acquired as the another user immediate transition information. FIG. 11B is an explanatory diagram of the another user immediate transition information according to embodiment 1. According to FIG. 11B, the transition information having the related ID “0002” and the number of transition “0010,” and the transition information having the related ID “0003” and the number of transition “0009” are acquired as the another user immediate transition information. Then, the processes of Step 1003 through Step 1009 will be executed only with respect to the another user immediate transition information of the record of the related ID “0002” having the largest number of transition.

Next, the identical transition user operation extraction unit 322 makes a determination as to whether or not a predetermined number of page IDs, which correspond to the transition history of the viewing user, has been acquired (1003). Note that even when the number of acquired page IDs, which correspond to the transition history of the viewing user, does not reach the predetermined number, when the number of transition of the acquired transition information includes “0000,” which indicates no previous acquisition information exists, the identical transition user operation extraction unit 322 determines that a predetermined number of transition history of the viewing user has been acquired. According to the present embodiment, the predetermined number is “5,” for example.

When it is determined in the process of Step 1003 that the predetermined number of page IDs, which correspond to the transition history of the viewing user, has not been acquired, the identical transition user operation extraction unit 322 acquires a previous transition information from the acquired transition information of the viewing user (1004). To be more specific, the identical transition user operation extraction unit 322 refers to the transition information table 331 so as to acquire as the transition information a record in which a related ID corresponding to the viewing user is registered at the related ID 601, and a value, which is obtained by subtracting 1 from the number of transitions in the acquired transition information, is registered at the number of transition 604.

Here, consider the transition history illustrated in FIG. 11C is acquired as the transition information (first transition information) of the viewing user. FIG. 11C is an explanatory diagram of the transition information of the viewing user according to embodiment 1. According to FIG. 11C, the page ID which indicates the transition history of the viewing user includes “B→C→D→E→F.”

When it is determined in the process of Step 1003 that that the predetermined number of page IDs, which indicate the transition history of the viewing user, has been acquired, the identical transition user operation extraction unit 322 makes a determination as to whether or not the number of page IDs, which indicate the acquired transition history of the another user, acquired is the same as the number of page IDs, which indicate the transition history of the viewing user (1005).

When it is determined in the process of Step 1005 that as many number of the page IDs, which indicate the transition history of the another user, as the number of the page IDs, which indicate the acquired transition history of the viewing user, have not been acquired, the identical transition user operation extraction unit 322 acquires a previous transition information of the transition information of the another user (1006). Note that the process of Step 1006 is the same as the process of Step 1004, and therefore the detailed description thereof will be omitted.

Consider that the transition information illustrated in FIG. 11D has been acquired as the predetermined piece of transition information (second transition information) of the another user. FIG. 11D is an explanatory diagram of the transition information of the another user according to embodiment 1. According to FIG. 11D, the page ID which indicates the transition history of the viewing user includes “B→C→D→E→F.”

When it is determined in the process of Step 1005 that as many number of the page IDs, which indicate the transition history of the another user, as the number of the page IDs, which indicate the acquired transition history of the viewing user, have been acquired, the identical transition user operation extraction unit 322 makes a determination as to whether or not the pages IDs, indicating the transition history of the viewing user, and the pages IDs, indicating the transition history of the another user, match with one another (1007). To be more specific, the identical transition user operation extraction unit 322 makes a determination as to whether or not the page IDs, indicating the transition history of the viewing user, that were acquired in the process of Step 1004 and the page IDs, indicating the transition history of the another user, that were acquired in the process of Step 1006 match with one another. In FIG. 11C and FIG. 11D, since each page ID indicating each user's transition history includes “B→C→D→E→F,” the identical transition user operation extraction unit 322 determines that the predetermined piece of transition history of the viewing user and the predetermined piece of transition history of the another user match with one another.

When it is determined in the process of Step 1007 that the page IDs, which indicate the transition history of the viewing user, and the page IDs, which indicate the transition history of the another user, match with one another, the identical transition user operation extraction unit 322 refers to the operation information table 332 so as acquire the operation content of the another user on the Web page which will be displayed next for the viewing user (1008), and ends the process. To be more specific, the identical transition user operation extraction unit 322 acquires, as the operation contents, the event 703 and the DOM 704 of a record in which a related ID of an another user immediate transition history acquired in the process of Step 1002 is registered at the related ID 701 of the operation information table 332, the transition destination page ID of the another user immediate transition history acquired in the process of Step 1002 is registered at the page ID 702, and the number of transition of the another user immediate transition history acquired in the process of Step 1002 is registered at the number of transition 705. For example, consider that the operation contents illustrated in FIG. 11E have been acquired. FIG. 11E is an explanatory diagram of the operation contents of the another user on the Web page which will be displayed next for the viewing user according to embodiment 1. According to FIG. 11E, the record of the operation information table 332, which includes “0002” for the related ID, “F” for the page ID, and “10” for the number of transition, is acquired as the operation contents.

When acquiring the operation content of the another user on the Web page the viewing user will display next, since the operation the operation content, having the number of transition that is the same as the number of transition of the another user immediate transition history acquired in the process of Step 1002, is acquired from the operation information table 332, it becomes possible to securely acquire the operation content that took place to transition to the Web page with the same transition history of the viewing user.

On the other hand, when it is determined in the process of Step 1007 that the page ID indicating the transition history of the viewing user does not match the page ID indicating the transition history of the another user, since the transition history of the another user does not match the transition history of the viewing user, the identical transition user operation extraction unit 322 will not execute the process of Step 1008, and will reject the related ID of the another user (1009), and will end the process. Note that when it is determined in the process of Step 1007 that the page ID indicating the transition history of the viewing user does not match the page ID indicating the transition history of the another user, the identical transition user operation extraction unit 322 may execute the processes of Steps 1005 through 1009 with respect to the record whose transition number is second largest from the another user immediate transition information acquired in the process of Step 1002.

By the above, it becomes possible to acquire the operation content on the Web page which the viewing user will view next from the operation content of the another user who has the same transition history as the transition history of the viewing user.

Next, a display modification script generation process executed by the display modification script generation unit 323 will be described with reference to FIG. 12.

Firstly, the display modification script generation unit 323 acquires the operation content extracted in the identical transition user operation extraction process by the identical transition user operation extraction unit 322. Then, the display modification script generation unit 323 generates a display modification script configured to modify the display of the DOM portion of the acquired operation content to correspond to the type of operation indicated by an event, embeds the generated display modification script in a Web page, and sends the same to the user terminal 10. What is meant by the display to correspond to the type of an operation may include, for example, when the portion was copied, or the like, a display where the portion is set to be copied to a clip board when the portion is clicked, or when the portion was clicked, the text, or the like, on the portion on the Web page will be displayed in an enlarged manner.

FIG. 12 is an explanatory diagram of the display modification script according to embodiment 1. According to FIG. 12, the script is configured to modify the display so that the background color of the portion where a copy operation took place changes.

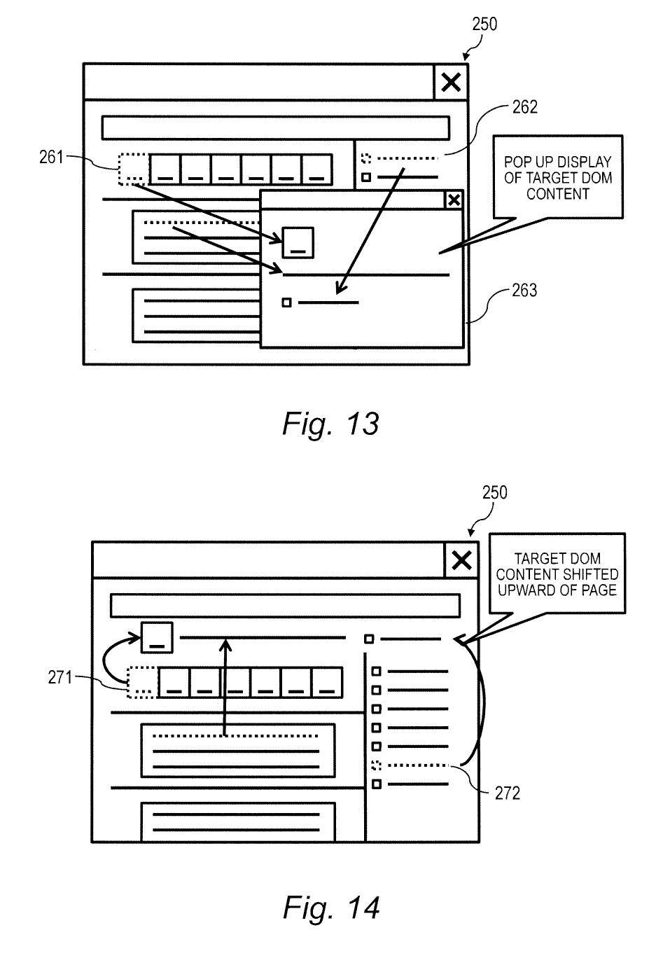

Next, what changes will be made in the display of a Web page in which the display modification script is embedded will be described with reference to FIG. 2, FIG. 13, and FIG. 14. FIG. 13 and FIG. 14 are explanatory diagrams each illustrating an exemplary display of a Web page according to embodiment 1.

As described with reference to FIG. 2, the portion of a display where an operation by another user took place may be, depending on the type of operation, displayed with an emphasis such as the background color and the color of the text are displayed in an inverted manner with respect to one another, or the text may be displayed in an emphasized manner by enlarging it, or the background color is modified so as to emphasize the portion.

According to FIG. 13, the contents of the portion of the display where another user had an operation (display areas 261 and 262) are displayed in a pop-up 263.

According to FIG. 14, the contents of the portion of the display where another user had an operation (display areas 271 and 272) are displayed by shifting them upward of the Web page.

By the above, according to the present embodiment, it becomes possible to reduce personnel expenses while providing the information a user demands with better accuracy by acquiring the operation content of another user who has the identical transition history as the user, who is currently viewing a Web page, and by modifying the Web page the currently viewing user will display next in accordance with the operation content of the another user.

### Embodiment 2

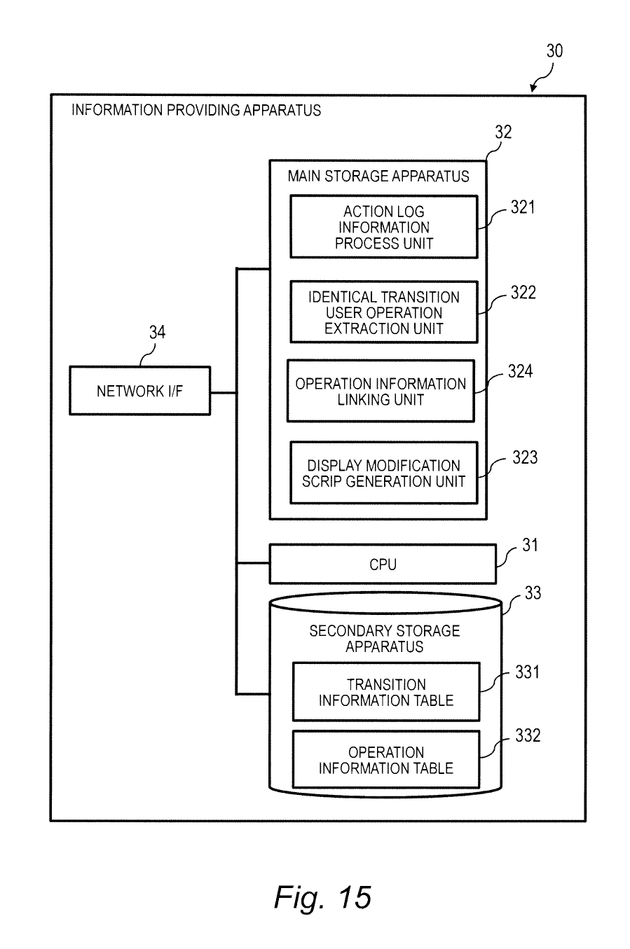

Hereinafter, embodiment 2 of the present invention will be described with reference to FIG. 15 through FIG. 17.

According to the present embodiment, the information providing apparatus 30 extracts a plurality of other users whose transition histories are identical to that of a viewing user, calculates a weight value for the type of the operation and DOM of the operation content of the other users on the Web page the viewing user will display next, and generates a display modification script based on the weight value. By this, the Web page will be displayed reflecting the operation contents of a plurality of users whereby it becomes possible to provide the information users demand with better accuracy.

FIG. 15 is a configuration diagram of the information providing apparatus 30 according to embodiment 2. Note that the configuration of the information providing apparatus 30 illustrated in FIG. 15 that is the same as the configuration of the information providing apparatus 30 according to embodiment 1 illustrated in FIG. 2 will be given the same reference numerals as those in FIG. 2 and the description thereof will be omitted.

The information providing apparatus 30 according to the present embodiment includes, in addition to the configuration according to embodiment, an operation information linking unit 324. The main storage apparatus 32 stores a program corresponding to the operation information linking unit 324, and, as the CPU 31 executes the program, the operation information linking unit 324 will be implemented.

The operation information linking unit 324 merges the operation contents on the next Web page by the plurality of other users whose transition histories are the same as that of the viewing user, and calculates the weight value which includes the operation at the same operated portion and the total of the number of the operation of the same type.

According to the present embodiment, the operation contents of the plurality of other users will be acquired in the identical transition user operation extraction process. For example, according to embodiment 1, out of the records having the transition history same as the transition history that is acquired in the process of Step 1001 the record having the largest number for the transition number is acquired as the another user immediate transition history in the process of Step 1002 illustrated in FIG. 10, whereas according to embodiment 2, all the records having the transition history same as the transition history that is acquired in the process of Step 1001 are acquired as the another user immediate transition history, and the processes of Steps 1005 through 1009 will be executed with respect to all the another user immediate transition histories. By this, it becomes possible to acquire all of the another user immediate transition histories having the same transition history as the viewing user.

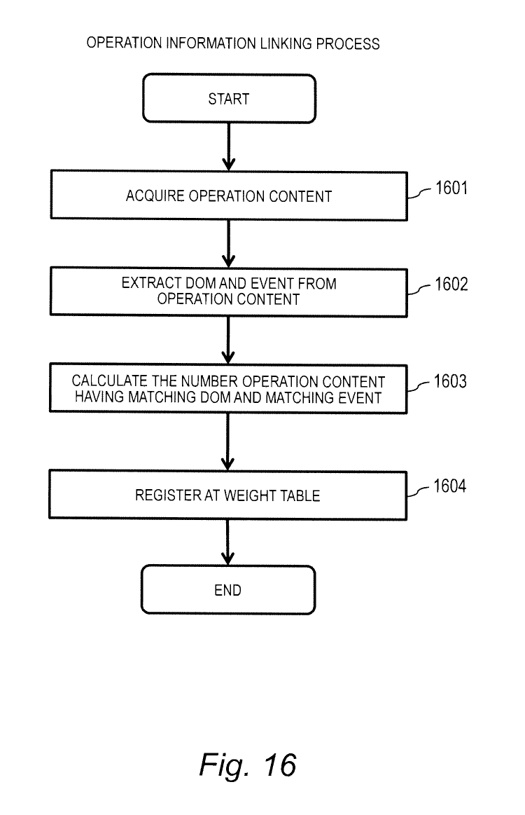

FIG. 16 is a flowchart of an operation information linking process according to embodiment 2. The operation information linking process will be executed by the operation information linking unit 324 after the identical transition user operation extraction unit 322 executes the identical transition user operation extraction process and before the display modification script generation unit 323 executes a display modification script process.

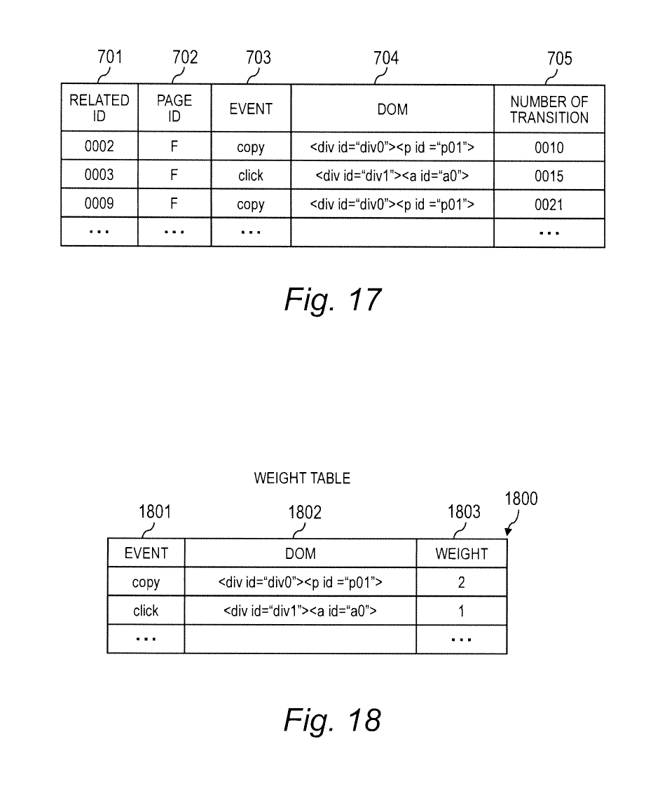

Firstly, the operation information linking unit 324 acquires the operation contents of a plurality other users that are extracted in the identical transition user extraction process which is executed by the identical transition user operation extraction unit 322 (1601). For example, the operation contents acquired in the process of Step 1601 are illustrated in FIG. 17. FIG. 17 is an explanatory diagram of the operation contents of the plurality of other users acquired by the operation information linking unit 324 according to embodiment 2. According to FIG. 17, the operation contents of users such as the related IDs “0002,” “0003,” and “0009” are acquired concerning the Web page which will be displayed next for the viewing user.

Next, the operation information linking unit 324 acquires the event and DOM from the operation contents which were acquired in the process of Step 1601 (1602). Then, the operation information linking unit 324 refers to the information acquired in the process of Step 1602, and calculates the number of operation contents whose DOMs match and whose events match (1603).

Then, the operation information linking unit 324 registers the number of operation contents calculated in the process of Step 1603, and the event and the DOM of the operation contents at a weight table 1800 (1604), and ends the process. The weight table 1800 will be described with reference to FIG. 18. FIG. 18 is an explanatory diagram of the weight table 1800 according to embodiment 2.

The weight table 1800 includes an event 1801, a DOM 1802, and a weight 1803. The event 1801 registers therein the event of the operation content acquired by the operation information linking unit 324, and the DOM 1802 registers therein the DOM of the operation content acquired by the operation information linking unit 324. Also, the weight 1803 registers therein the weight calculated by the operation information linking unit 324.

For example, when the operation contents illustrated in FIG. 17 are acquired in the process of Step 1601, since the event “copy” and the DOM “<div id=“div0”><p id=“p01”>” appear in 2 operation contents: the related IDs “0002” and “0009,” the weight of the operation contents will be calculated as “2.” Accordingly, in the process of Step 1604, “copy” is registered at the event 1801, “<div id=“div0”><p id=“p01”” is registered at the DOM 1802, and “2” is registered at the weight 1803 in the weight table 1800. Also, since the event “click” and the DOM “<div id=“div1”><a id=“a0”>” appear only in the operation content: the related ID “0003,” the weight of the operation content will be calculated as “1.” Accordingly, in the process of Step 1604, “click” is registered at the event 1801, “<div id=“div1”><a id=“a0”>” is registered at the DOM 1802, and “1” is registered at the weight 1803 in the weight table 1800.

The display modification script generation unit 323 generates the display modification script based on the weight 1803 of the weight table 1800. For example, when enlarging texts, the rate of enlargement may be in accordance with the weight. Also, when changing the background color compared with the texts, the background color of the Web page may be made closer to a predetermined color (yellow, or the like, for example) or a color that is more complimentary to the text color in accordance with the weight. Also, when changing the text color, the text color may be made closer to the color more complimentary to the background color of the Web page from the default white in accordance with the size of the weight.

By this, it becomes possible to provide the information the user demands with better accuracy as it is possible to display the Web page the viewing user will display next with an emphasis at the portion thereof where a large number of same type of operations take place compared with other portions.

### Embodiment 3

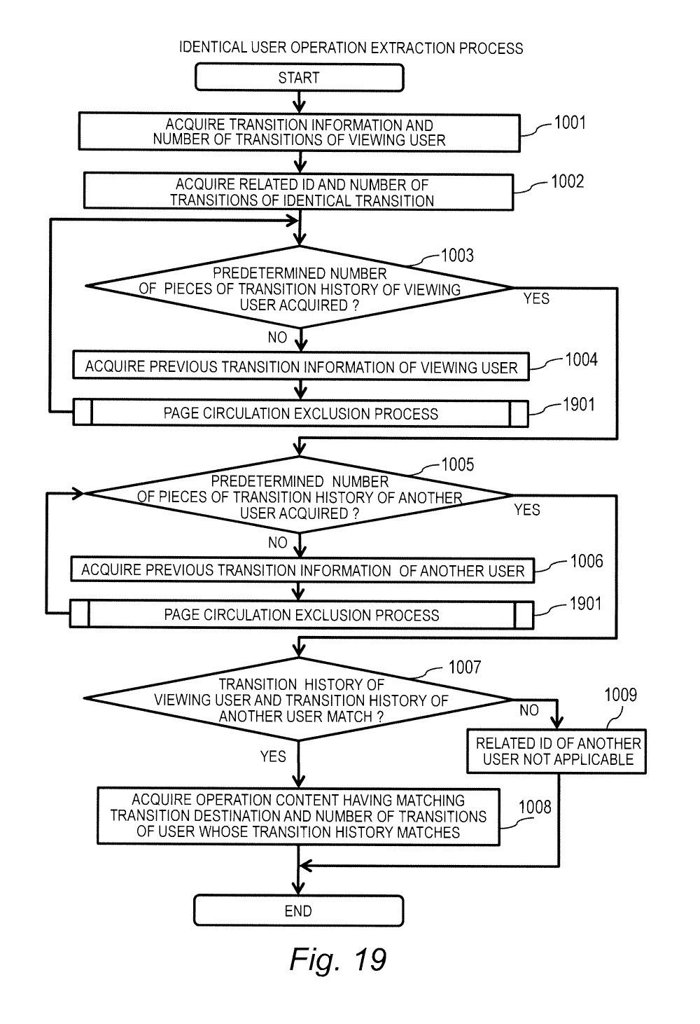

Hereinafter, embodiment 3 of the present invention will be described with reference to FIG. 19 through FIG. 21.

According to the present embodiment, in the process to acquire the transition information of the viewing user and the process to acquire the transition information of anther user, when the page ID, which indicates the viewing user or another user transition history, includes the same page ID, a page circulation exclusion process configured to exclude the page ID between 2 Web page IDs.

FIG. 19 is a flowchart of the identical transition user operation extraction process according to embodiment 3. Of the processes illustrated in FIG. 18, the processes that are the same as those in the identical transition user operation extraction process according to embodiment 1 illustrated in FIG. 10 will be given the same reference numerals as those in FIG. 10 and the description thereof will be omitted.

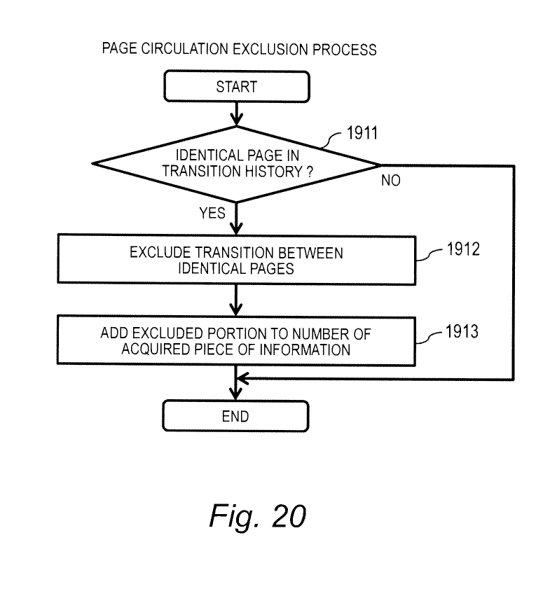

In the identical transition user operation extraction process according to the present embodiment, the page circulation exclusion process will be executed after executing the processes of Steps 1004 and 1006. The page circulation exclusion process will be described with reference to FIG. 20.

FIG. 20 is a flowchart of the page circulation exclusion process according to embodiment 3.

Firstly, the identical transition user operation extraction unit 322 makes a determination as to whether or not the page IDs which indicate the transition history include any repeated Web page IDs (1911).

When it is determined in the process of Step 1911 that the page IDs which indicate the transition history include repeated Web page IDs, the identical transition user operation extraction unit 322 excludes the page ID between the repeated pages (1912). Then, the identical transition user operation extraction unit 322 adds the number of pieces of transition information corresponding to the number of page IDs excluded in the process of Step 1912 to the number of pieces of transition information to be added (1913), and ends the process.

On the other hand, when it is determined in the process of Step 1911 that the page IDs which indicate the transition history do not include repeated Web page IDs, the identical transition user operation extraction unit 322 ends the process without executing the processes of Steps 1912 and 1913.

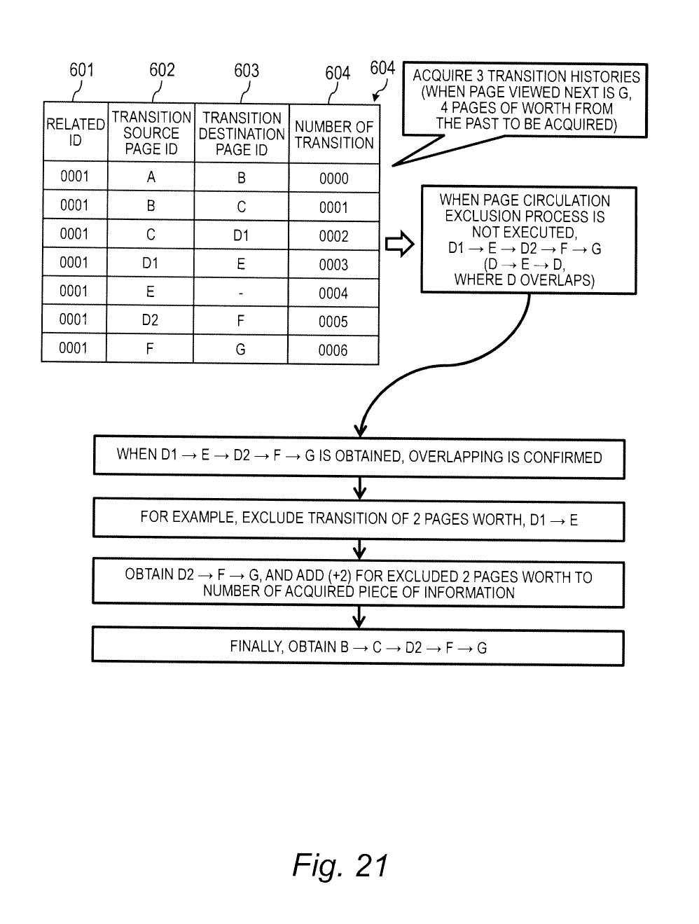

FIG. 21 is an explanatory diagram of the page circulation exclusion process according to embodiment 3.

The transition history of a user whose related ID includes “0001” is indicated in the transition history 2100 in FIG. 21. Note that while “D1” and “D2” of the page ID indicated in the transition history 2100 indicate the same page ID “D,” in order to simplify the description, they will be referred to as “D1” and “D2.”

Here, a number of pieces of transition history to be acquired is “3,” and therefore, unless the page circulation exclusion process is executed, the page IDs which indicate the transition history will include “D1→E→D2→F→G” to show the page IDs which indicate the transition history include repeated page IDs.

In the page circulation exclusion process illustrated in FIG. 20, the identical transition user operation extraction unit 322 determines in the process of Step 1911 that page IDs “D1” and “D2” are repeated as soon as the transition information of the number of transition “0003” is acquired. Then, the identical transition user operation extraction unit 322 excludes the “D1→E” in the process of Step 1912. That is, of the page IDs between the repeated page IDs, the page ID that was acquired after the acquisition of the page ID “D2” is excluded.

Then, the identical transition user operation extraction unit 322 adds the number of pieces of transition information to be newly acquired to correspond to those 2 page IDs that were excluded, and ends the process. According to FIG. 21, the number of transitions “0002” and “0001” are acquired, and the page ID “B→C” which indicates the transition history is acquired. Finally, the group of page IDs that indicate the transition will include “B→C→D2→F→G.”

By this, by excluding the portion of the transition history where page transition circulates, only the final transition history is acquired so as to improve the accuracy of extraction of another user whose transition history matches the transition history of the viewing user.

This invention is not limited to the embodiments described above, and encompasses various modification examples. For instance, the embodiments given above are detailed descriptions that are written for easy understanding of this invention, and this invention is not necessarily limited to a mode that includes all the components described above. Replacing some components of one embodiment with components of another embodiment is also an option. Components of one embodiment may be added with components of another embodiment. For some components in each embodiment, other components may be added or deleted or may substitute.

Some of or all of the components, functions, processing parts, processing measures, and the like described above may be implemented by hardware by, for example, designing those in the form of an integrated circuit. Alternatively, the components, functions, and the like described above may be implemented by software by having a processor interpret and execute programs that respectively implement the above-mentioned functions. Programs, tables, files, and other types of information for implementing the above-mentioned functions can be put in a memory, a recording device such as a hard disk or a solid state drive (SSD), or a recording medium such as an IC card, an SD card, or a DVD.

The control lines and information lines given above are ones deemed as necessary to describe this invention, and not all of control lines and information lines of a product are necessarily given above. It may be considered that almost all components are connected to one another in actuality.

What is claimed is:

1. An information providing method to modify a display of a Web page provided to a terminal appropriately to a user of a computer configured to acquire an action log of the user of the terminal,
wherein the action log includes identification information of the Web page and an operation content on the Web page by the user,
wherein the method includes:
a step of acquiring, by the computer, the action log;
a step of saving, by the computer, information related to a transition of the Web page as transition information based on the acquired action log;
a step of saving, by the computer, an operation content included in the acquired action log as operation information;
a step of extracting, by the computer, a user having a transition history same as a transition history of a user currently viewing a Web page by referencing the transition information;
a step of acquiring, by the computer, an operation content of the extracted user on a Web page the user currently viewing a Web page views next by referencing the operation information; and
a step of modifying, by the computer, based on the acquired operation content, a display of the Web page the user currently viewing a Web page views next.

2. The information providing method according to claim 1,
wherein the action log includes user identification information to identify the user, and
wherein between the transition information and the operation information, information related to a transition and an operation content of an identical user are correlated by related identification information based on the user identification information included in the action log.

3. The information providing method according to claim 2,
wherein in the step of extracting the user, the computer refers to the transition information and acquires the related identification information of the transition history the same as the transition history of the user currently viewing a Web page, and
wherein in the step of acquiring the operation content, the computer refers to the operation information and acquires an operation content on a Web page the user currently viewing a Web page views next and corresponding to the acquired related identification information.

4. The information providing method according to claim 2,
wherein in the step of saving the transition information and the step of saving the operation information, the computer generates a unique related identification information based on the user identification information.

5. The information providing method according to claim 4,
wherein the user identification information includes a session ID between the terminal and a Web server configured to provide the Web page, and
wherein in the step of generating the related identification information, the computer generate the related identification information by executing a predetermined conversion process with respect to the session ID.

6. The information providing method according to claim 1,
wherein the step of extracting the user includes:
extracting, by the computer, a transition history going back from a Web page currently being viewed to a predetermined number as a first transition history;
extracting, by the computer, a transition history having an equal number of transition history as the first transition history out of a transition history of a user other than the user currently viewing a Web page as a second transition history; and
extracting, by the computer, a user having the second transition history as the user having the transition history the same as the transition history of the user currently viewing a Web page in a case where the extracted first transition history and the extracted second transition history match.

7. The information providing method according to claim 6,
wherein in the step of saving the transition information, the computer calculates a number of transition from a Web page which is a first transition source for each user to Web page of each transition history, correlates the calculated transition number with information related to the transition, and saves the correlation as the transition information;
wherein in the step of extracting the first transition history, the computer refers to the number of transition and extracts the predetermined number of transition history as the first transition history; and
wherein in the step of extracting the second transition history, the computer refers to the number of transition and extracts, as the second transition history, the transition history having same number as the transition history extracted as the first transition history.

8. The information providing method according to claim 7,
wherein the step of saving the operation information, the computer saves an operation content on a Web page correlated with the number of transition up to the Web page, as the operation information, and
wherein in the step of acquiring an operation content of the user, the computer refers to the operation information, and acquires an operation content by the extracted user on a Web page the user currently viewing a Web page views next and matching the number of transition corresponding to the Web page to be viewed next out of the extracted transition history as the second transition history.

9. The information providing method according to claim 6,
wherein in the step of extracting the first transition history, in a case where the extracted transition history includes a repeated transition to a same page, the computer excludes a transition history between the repeated transition to a same page from the first transition history, and
wherein in the step of extracting the second transition history, in a case where the extracted transition history includes a repeated transition to a same page, the computer excludes a transition history between the repeated transitions to a same page from the second transition history.

10. The information providing method according to claim 1,
wherein in the step of extracting the user, the computer extracts a plurality of users having a transition history the same as the transition history of the user currently viewing a Web page,
wherein in the step of acquiring the operation content, the computer calculates, as a weight value, a number of a plurality of users having an identical operation content on the Web page to be viewed next, and
wherein in the step of modifying a display, the computer modifies, based on the acquired operation content and the weight value, a display of a Web page the user currently viewing a Web page views next.

11. The information providing method according to claim 1,
wherein an operation content included in the action log includes an HTML tag of an operated portion of the Web page, and
wherein in the step of saving the operation information, the computer saves the HTML tag of the operated portion of the Web page as the operation information.

12. The information providing method according to claim 1,
wherein information related to the transition includes identification information of a transition source Web page and identification information of a transition destination Web page, and
wherein the step of saving the transition information, in a case of saving information related to a transition having no identification information of the transition destination Web page since the Web page is closed, the computer registers a value indicating the closing of the Web page in the identification information of the transition destination Web page, and saves the transition information.

13. The information providing method according to claim 1,
wherein in the step of modifying a display of a Web page the user currently viewing a Web page views next, a script to modify a display of the Web page is embedded based on the acquired operation content and sent to the terminal to modify the display of the Web page.

14. An information providing apparatus configured to acquire an action log of a user of a terminal and to provide a display of a Web page by modifying the display appropriately to the user,
wherein the action log includes identification information of the Web page and an operation content of a user on the Web page,
wherein the information providing apparatus acquires the action log,
wherein the information providing apparatus extracts a transition of the Web page based on the acquired action log, and saves information related to the extracted transition as transition information,
wherein the information providing apparatus saves an operation content included in the acquired action log as operation information,
wherein the information providing apparatus refers to the transition information and extracts a user having a transition history the same as a transition history of a user currently viewing a Web page,
wherein the information providing apparatus refers to the operation information and acquires an operation content of the extracted user on a Web page the user currently viewing a Web page views next, and
wherein the information providing apparatus modifies based on the acquired operation content a display of the Web page the user currently viewing a Web page views next.

15. A program configured to be implemented by a computer acquiring an action log of a user of a terminal, and having a processor and a storage area, and to have the processor execute a process to modify a display of a Web page provided to the terminal appropriately to the user,
wherein the action log includes identification information of the Web page and an operation content of a user on the Web page,
wherein the process includes:
a step of acquiring the action log;
a step of extracting a transition of the Web page based on the acquired action log, and saving information related to the extracted transition as transition information;
a step of saving an operation content included in the acquired action log as operation information;
a step of extracting, by referring to the transition information, a user having a transition history the same as a transition history of a user currently viewing a Web page;
a step of acquiring, by referring to the operation information, an operation content of the extracted user on a Web page the user currently viewing a Web page views next; and
a step of modifying, based on the acquired operation content, a display of the Web page the user currently viewing a Web page views next.
